(19) United States
(12) Patent Application Publication
(10) Pub. No.: US 2018/0325150 A1
(43) Pub. Date: Nov. 15, 2018

(54) METHODS, COMPOSITIONS, AND KITS FOR PREPARING A MEAL

(71) Applicant: Bountiful Eye, LLC, Lakeland, FL (US)

(72) Inventor: Jane Hammond, Lakeland, FL (US)

(73) Assignee: Bountiful Eye, LLC, Lakeland, FL (US)

(21) Appl. No.: 15/977,345

(22) Filed: May 11, 2018

Related U.S. Application Data
(60) Provisional application No. 62/506,456, filed on May 15, 2017.

(51) Int. Cl. A23L 19/00; A23L 7/10; A23L 27/00

(52) U.S. Cl. CPC A23L 19/03; A23V 2002/00; A23L 27/00; A23L 7/10

(57) ABSTRACT

The present disclosure provides methods and compositions for preparing a meal, an enclosure including multiple packets, meal kits, and a self-service machine for selecting a meal. The disclosure provides healthy meals that are easy to prepare and provide variety. Furthermore, the meals are well-suited for delivery to needy individuals because they are individually packaged, easy-to-prepare, and can have long shelf life and contain healthy ingredients.

### RELATED APPLICATIONS

This application claims the benefit of U.S. Ser. No. 62/506,456 filed on May 15, 2017, which is incorporated by reference herein in its entirety.

### FIELD OF THE INVENTION

This disclosure relates to the field of meal preparation, and methods, kits, and compositions for the same.

### BACKGROUND OF THE DISCLOSURE

Food scarcity is a problem for many people around the world, particularly people who have difficulty acquiring and preparing meals by themselves. For example, it is often difficult for elderly, people recently discharged from a hospital, and people with physical handicaps to go to the grocery store and, after acquiring the necessary ingredients, prepare meals in the kitchen by themselves. This often leads people facing food scarcity to select less healthy foods that are more easily prepared. In addition, the shelf-life of food products, and potential food waste upon expiration, is a significant concern, especially for people facing food scarcity and for people or entities assisting such people. In a hospital post-discharge setting, hospitals can incur fines for high readmission rates for seniors, which can be a result of poor nutrition post discharge.

One method to combat food scarcity and promote healthier selections is through the use of packaged meals that are healthy, shelf-stable, and easy-to-prepare. In addition, variable combinations of ingredients permit people to prepare the meal according to their preferences and are more desirable. Previous methods and compositions have been found lacking in at least one of these characteristics. Canned foods are shelf-stable, but contain high levels of sodium that are unhealthy. Furthermore, canned food is not normally variable and the cans can be difficult to open, especially for senior citizens. Some easy-to-prepare meals are not shelf-stable and therefore storage is a concern for the consumers as well as volunteers that provide meals to people affected by food scarcity. Furthermore, such easy-to-prepare meals do not allow the consumer to mix and match different components to provide some individuality and sense of accomplishment to the consumer.

There remains a need for easy-to-prepare, but healthy and flexible meal kits that would allow hospitals to store and dispense these items to patients upon their discharge. Currently, discharged patients and/or their caregivers may be provided with unhealthy food upon discharge, with limited options, or they have to acquire the ingredients for meal preparation, or order unhealthy prepared meals, such as fast-food items.

There remains a need for meal preparation, meal kits, and enclosures that are healthy, shelf-stable, easy-to-prepare, and have variety.

### SUMMARY

The present disclosure provides methods, compositions, and enclosures that meet these needs. In one aspect, provided herein are methods for preparing a meal, including: a) selecting, from a first set of packets, a spice-vegetable packet including a pre-portioned amount of one or more spices and a pre-portioned amount of one or more vegetables, wherein each packet of the first set of packets is a packet that is typically sealed and includes a different mixture of one or more spices and one or more vegetables. In certain embodiments the vegetables are either one or more whole vegetables or one or more sliced vegetables having a volume of at least 1/20 the volume of the corresponding whole vegetable, or both one or more whole vegetables and one or more sliced vegetables having a volume of at least 1/20 the volume of the corresponding whole vegetable. In certain embodiments, the vegetables have been air dried and/or have not been subjected to a temperature below 0° C. In some embodiments, the first set of packets can include at least 3 packets with different mixtures of one or more spices and one or more vegetables. The methods can further include b) selecting, from a second set of packets that are typically sealed, a carbohydrate packet that can include a pre-portioned amount of one or more sources of carbohydrates wherein each packet of the second set of packets that includes a different source of carbohydrates. In some embodiments, the second set of packets can include at least 3 packets with different sources of carbohydrates. The methods can further include c) combining the contents of the selected spice-vegetable packet and the contents of the selected carbohydrate packet into a volume of water to form a mixture, and can further include d) heating the mixture under conditions to cook the mixture for no more than 5 minutes in a microwave oven and, in illustrative embodiments, allowing to sit in a container for no less than 5 minutes thereafter. In illustrative embodiments, the container can be a closed or loosely covered container. In some embodiments, after the heating, the one or more vegetables can be identifiable visually and/or can be visually indistinguishable to a consumer from a fresh sample of the same type of vegetable. The easy-to-prepare meals can be prepared by combining no more than 2, 3, 4, or 5 total packets. In illustrative embodiments, the meal and/or the packets can be healthy according to various standards. For example, the first or second packet can further include a pre-portioned amount of one or more sources of protein, the meal and/or the packets can be low sodium, not include artificial preservatives, and/or have a low glycemic index. In illustrative embodiments, the packets can be shelf-stable for at least 3, 6, 9, or 12 months. The packets can be easy to open such that a person that typically has difficulty opening packets or enclosures can open the packets. For example, the packets can be plastic and/or the packets can be opened by unzipping a plastic zipper. In some embodiments, the methods can further include preparing a second meal.

In another aspect, provided herein are enclosures that include: a first set of packets, wherein each packet of the first set of packets is a packet that is typically sealed and includes a pre-portioned amount of a different mixture of one or more spices and one or more vegetables, wherein the vegetables are one or more whole vegetables and/or one or more sliced vegetables having a volume at least 1/20 the volume of the corresponding whole vegetable. In some embodiments the vegetables have been air dried and/or have not been subjected to a temperature below 0° C. In some embodiments, the first set of packets can include at least 3 packets with different mixtures of one or more spices and one or more vegetables. The enclosures further include a second set of packets that are typically sealed, wherein each packet of the second set of packets includes a pre-portioned amount of one or more sources of carbohydrates, wherein the enclosure includes at least 6 total packets including the first set of packets and the second set of packets. In some embodiments, the second set of packets can include at least 3 packets with different sources of carbohydrates. In illustrative embodiments, the packets can be healthy according to various standards. For example, the first or second packet can further include a pre-portioned amount of one or more sources of protein, the meal and/or the packets can be low sodium, not include artificial preservatives, and/or have a low glycemic index. In illustrative embodiments, the packets can be shelf-stable for at least 3, 6, 9, or 12 months. The packets can be easy to open such that a person that typically has difficulty opening packets or enclosures can open the packets. For example, the packets can be plastic and/or the packets can be opened by unzipping a plastic zipper.

In another aspect, provided herein are meal kits for preparing at least two distinct hot meals, said meal kits include an outer container and a plurality of packets located within the outer container, wherein the plurality of packets includes: a first set of packets, wherein each packet of the first set of packets is a packet that is typically sealed and includes a pre-portioned amount of a mixture of one or more spices and one or more vegetables, wherein the vegetables are one or more whole vegetables and/or or one or more sliced vegetables having a volume at least 1/20 the volume of the corresponding whole vegetable. In some embodiments, the vegetables have been air dried and/or have not been subjected to a temperature below 0° C. In some embodiments, the first set of packets can include at least 3 packets with different mixtures of one or more spices and one or more vegetables. The meal kits further include a second set of packets, wherein each packet of the second set of packets is typically sealed and includes a pre-portioned amount of one or more sources of carbohydrates, wherein the meal kits include at least total 6 packets including the first set of packets and the second set of packets. In some embodiments, the second set of packets can include at least 3 packets with different sources of carbohydrates. In some embodiments, after heating, the one or more vegetables can be identifiable visually and/or can be visually indistinguishable from a fresh sample of the same type of vegetable. In illustrative embodiments, the meal kits and/or the packets can be healthy according to various standards. For example, the first or second packet can further include a pre-portioned amount of one or more sources of protein, the meal kits and/or the packets can be low sodium, not include artificial preservatives, and/or have a low glycemic index. In illustrative embodiments, the meal kits and/or the packets can be shelf-stable for at least 3, 6, 9, or 12 months. The meal kits and/or the packets can be easy to open such that a person that typically has difficulty opening packets or containers can open them. For example, the packets can be plastic and/or the packets can be opened by unzipping a plastic zipper. In some embodiments, the methods can further include preparing a second meal. In some embodiments, the meal kit further includes a microwaveable container.

In another aspect, provided herein are self-service machines for selecting a meal, including a) presenting a first set of packets, wherein each packet of the first set of packets is a sealed packet including a pre-portioned amount of a mixture of one or more spices and one or more vegetables, wherein the vegetables are one or more whole vegetables and/or one or more sliced vegetables having a volume at least 1/20 the volume of the corresponding whole vegetable. In some embodiments, the vegetables have been air dried and/or have not been subjected to a temperature below 0° C. In some embodiments, the first set of packets can include at least 3 packets with different mixtures of one or more spices and one or more vegetables. The self-service machines further include b) presenting a second set of packets, wherein each packet of the second set of packets includes a pre-portioned amount of one or more sources of carbohydrates. In some embodiments, the second set of packets can include at least 3 packets with different sources of carbohydrates. The self-service machines further include c) providing a functionality for selecting a first packet from the first set of packets, and a second packet from the second set of packets, thereby selecting the meal. In some embodiments, after heating, the one or more vegetables can be identifiable visually and/or can be visually indistinguishable from a fresh sample of the same type of vegetable. In illustrative embodiments, the packets can be healthy according to various standards. For example, the first or second packet can further include a pre-portioned amount of one or more sources of protein, the packets can be low sodium, not include artificial preservatives, and/or have a low glycemic index. In illustrative embodiments, the packets can be shelf-stable for at least 3, 6, 9, or 12 months. The packets can be easy to open such that a person that typically has difficulty opening packets or containers can open them. For example, the packets can be plastic and/or the packets can be opened by unzipping a plastic zipper. In some embodiments, the methods can further include preparing a second meal.

### BRIEF DESCRIPTION OF THE DRAWINGS

FIG. 1 shows a flow diagram of a method of preparing a meal of the present disclosure. First, the method includes selecting a first packet, which includes a spice-vegetable mixture (110). Then, the method includes selecting a second packet, which includes a source of carbohydrates (120). Next, the method includes combining the first and second packets with a volume of water (130) and then heating the mixture in a microwave oven (140). After heating, the method includes allowing the mixture to sit in a container (150) and the meal is ready for consumption.

FIG. 2 shows a flow diagram of a method of preparing a meal of the present disclosure. First, the method includes selecting a first packet, which includes a spice-vegetable mixture (210). Then, the method includes selecting a second packet, which includes a source of carbohydrates (220). Next, the method includes combining the first packet with a volume of water (230) to form a first mixture and then heating the first mixture in a microwave oven (240). After heating, the method includes combining the second packet with the first mixture to form a second mixture and allowing the mixture to sit in a container and the meal is ready for consumption.

### DEFINITIONS

As used herein, the phrases “sodium free” and “salt free” refer to meals, enclosures, meal kits, and/or packets with less than 5 mg of sodium per reference amounts customarily consumed.

As used herein, the phrase “very low sodium” refers to meals, enclosures, meal kits, and/or packets with 35 mg or less of sodium per reference amounts customarily consumed.

As used herein, the phrase “low sodium” refers to meals, enclosures, meal kits, and/or packets with 140 mg or less of sodium per reference amounts customarily consumed.

As used herein, the phrase “reduced sodium” or “less sodium” refer to meals, enclosures, meal kits, compositions, and/or packets with 25% less sodium per reference amounts customarily consumed than a corresponding reference food.

As used herein, the phrase “fat free” refers to meals, enclosures, meal kits, and/or packets with 0.5 grams of fat per reference amounts customarily consumed.

As used herein, the phrase “low fat” refers to meals, enclosures, meal kits, and/or packets with 3 grams of fat per reference amounts customarily consumed.

As used herein, the phrases “reduced fat” or “less fat” refer to meals, enclosures, meal kits, and/or packets with 25% less fat per reference amounts customarily consumed than an appropriate reference food.

As used herein, the phrase “low glycemic index” refers to meals, enclosures, meal kits, and/or packets with a glycemic index of 55 or less.

As used herein, the phrase “medium glycemic index” refers to meals, enclosures, meal kits, and/or packets with a glycemic index of 56-69.

As used herein, the term “shelf-stable” refers to meals, enclosures, meal kits, and/or packets that can be safely stored at room temperature for a specified amount of time. In order to be shelf-stable, food can be treated by heat and/or dried to destroy foodborne microorganisms that can cause illness or spoil food.

As used herein, the term “serving” refer to an amount customarily consumed for a reference food. For illustrative meal kits provided herein, a serving can be 200, 400, 600 g of food.

It is to be understood that the present disclosure and the aspects and embodiments provided herein, are not limited to particular examples disclosed, as such may, of course, vary. It is also to be understood that the terminology used herein is for the purpose of disclosing particular examples and embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. When multiple low and multiple high values for ranges are given, a skilled artisan will recognize that a selected range will include a low value that is less than the high value.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a,” “an,” and “the” include plural referents unless the context clearly dictates otherwise. Thus, for example, reference to “a packet” includes a plurality of such packets and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

### DETAILED DESCRIPTION

The methods, compositions, packets, meal kits, and enclosures disclosed herein provide easy-to-prepare food items that provide variety for a consumer, which for a sick or aged individual, can provide some excitement and sense of accomplishment. The food items in illustrative embodiments are healthy having low sodium and/or low fat, having no artificial ingredients such as artificial coloring or preservatives, and/or have a low glycemic index. The food items of the methods, compositions, packets, kits and enclosures herein, can be stable for months or even over a year, thus providing convenience for a consumer and shipping companies who deliver meals to individuals who cannot easily go to a grocery store.

The methods, enclosures, and meal kits provided herein would allow hospitals to store and dispense these items to patients upon their discharge. The discharged patients would not have to bother acquiring the ingredients for meal preparation or the difficult or time-consuming steps necessary for meal preparation. For food delivery services, the enclosures and meal kits provided herein can provide a means to increase the number of meals provided to each person without worrying about loss of product. In addition to the delivery of a hot meal, these services could provide a meal kit or enclosure to further supplement the meals of people. The enclosures and meal kits provided herein can also be used where fresh food is not easily accessible, such as in areas with grocery stores that do not sell fresh produce (known as food deserts), on long trips, such as could be encountered in an airplane, a ship, a spaceship, or a space station, in military zones, in remote areas, or on planetary bodies other than Earth.

In one aspect, methods of preparing a meal are provided to make variable meals while also providing the consumer ease and convenience, and in illustrative examples shelf stability for long-term storage and flexible delivery. The methods of the present disclosure include multiple packets of food with no requirements for additional ingredients or food, although in some embodiments the methods are flexible and can allow the user to add additional ingredients and food. The methods provide an easy way to prepare a savory meal by a consumer. The consumer enjoys a tasty meal while avoiding the inconvenience of having to prepare it from scratch or having to separately purchase and store addition ingredients necessary to prepare the meal. In illustrative embodiments, the meals include dried vegetables that when rehydrated are recognizable and in some cases, have the color and texture of freshly prepared vegetables. In illustrative embodiments, the packets are shelf-stable such that the consumer of a food delivery service can store the ingredients for extended periods without being concerned about food spoilage or expiration. Healthy options are also an important factor for consumers. In illustrative embodiments, the meal and/or the packets can be low sodium, have no artificial preservatives, have low glycemic content, and/or no food coloring.

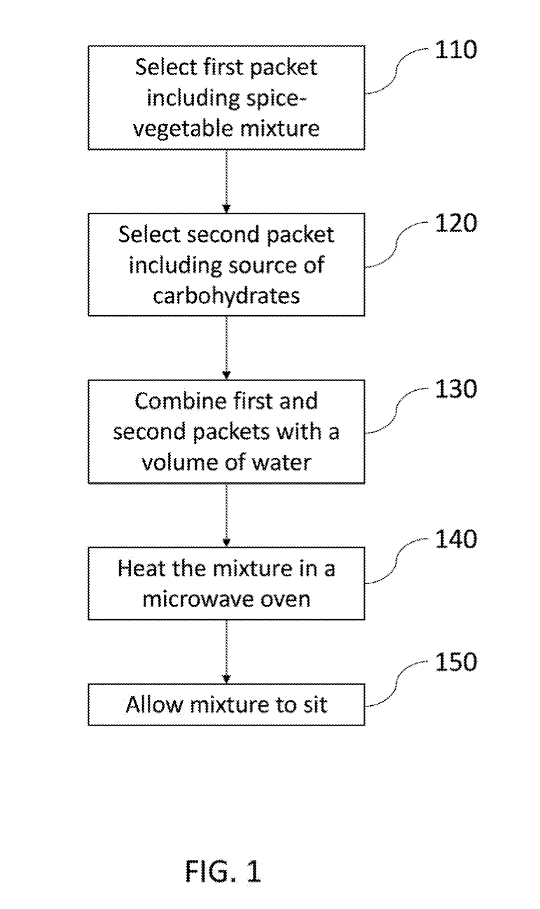

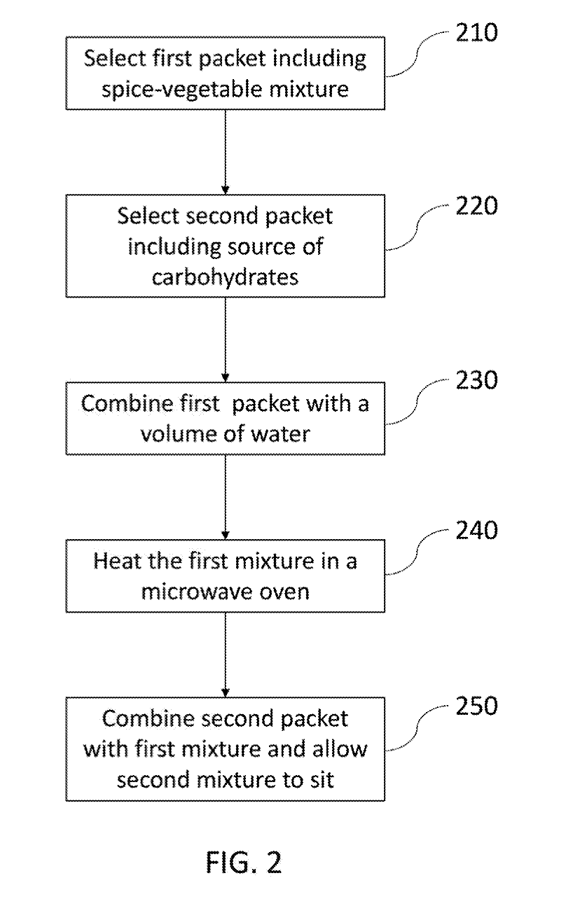

Referring now to the flow chart of FIG. 1, in certain aspects, provided herein are methods for preparing a meal. The methods include a) selecting, from a first set of packets, a spice-vegetable packet (110) including a pre-portioned amount of one or more spices and a pre-portioned amount of one or more vegetables, wherein each packet of the first set of packets is a sealed packet that includes a different mixture of one or more spices and one or more vegetables, wherein the vegetables are whole or sliced vegetables. In some embodiments, the one or more vegetables can have a volume of at least 1/50, 1/40, 1/30, 1/25, 1/20, 1/10, ⅕, or ¼ the volume of the corresponding whole vegetable. In illustrative embodiments, the one or more vegetables can have a volume of at least 1/20 the volume of the corresponding whole vegetable. In other embodiments, the one or more vegetables can have a volume of at least 0.5 cm³, 0.75 cm³, 1 cm³, or 1.25 cm³. Furthermore, the vegetables are typically air dried and/or not subjected to an extreme temperature, for example a temperature above 42° C. or have not been subjected to a temperature below 0° C. The methods further can include b) selecting, from a second set of packets, a carbohydrate packet including a pre-portioned amount of one or more sources of carbohydrates (120) wherein each packet of the second set of packets includes a different source of carbohydrates. Next, the methods can include c) combining the contents of the selected spice-vegetable packet and the contents of the selected carbohydrate packet into a volume of water (130) in a container to form a mixture. Next, the methods include d) heating the mixture (140). For example, the mixture can be cooked for no more than 1, 2, 3, 4, 5, 6, 7, 8, 9, or 10 minutes in a microwave oven. The mixture can then be allowed to sit (150), thereby preparing the meal. In illustrative embodiments, the container is closed or loosely covered during part or all of the sitting period. For example, the mixture can be allowed to sit in a closed container long enough for it to cool to a temperature that will not burn a person eating it, for example allowing it to cool to a temperature below 200° F., 195° F., 190° F., 185° F., 180° F., 175° F., 170° F., 165° F., or 160° F. For example, the mixture can be allowed to sit for 1 to 60 minutes, 2 to 45 minutes, or 5 to 30 minutes, or for no less than 2 minutes, 5 minutes, or 10 minutes. In illustrative embodiments, the food can sit in a closed container. In some embodiments, the method can further include preparing a second meal, wherein the second meal is prepared by repeating steps a) to d) to select a different combination of the spice-vegetable mixture packet and the carbohydrate packet from the first meal. In some embodiments, the method can further include preparing a third meal, wherein the third meal is prepared by repeating steps a) to d) to select a different combination of the spice-vegetable mixture packet and the carbohydrate packet from the first and second meals. In some embodiments, the mixture can be heated for no more than 1, 2, 3, 4, 5, 6, 7, 8, 9, or 10 minutes. In some embodiments, the mixture can be allowed to sit in a container for no less than 1, 2, 3, 4, 5, 6, 7, 8, 9, or 10 minutes. In illustrative embodiments, the food can sit in a closed or loosely covered container. As shown in FIG. 2, in some embodiments, in place of steps c) and d), the method can include c) combining the contents of the selected spice-vegetable packet into a volume of water (230) to form a first mixture, and d) heating the first mixture, combining the contents of the selected carbohydrate packet into the first mixture to form a second mixture, and allowing the second mixture to sit in a closed or loosely covered container, thereby preparing the meal.

In some embodiments, the meal can be prepared by combining between 2, 3, 4, and 5 packets on the low end of the range and 3, 4, 5, 6, 7, 8, 9, and 10 packets on the high end of the range. In some embodiments, the meal can be prepared by combining no more than 2, 3, 4, 5, 6, 7, 8, 9, or 10 packets. In some embodiments, no additional steps are performed to prepare the meal.

Variety is important for encouraging selection of healthy foods. In some embodiments, the first set of packets can include at least 2, 3, 4, 5, 6, 7, 8, 9, or 10 packets with different mixtures of one or more spices and one or more vegetables. In some embodiments, the second set of packets can include at least 2, 3, 4, 5, 6, 7, 8, 9, or 10 packets with different sources of carbohydrates. In any of the embodiments disclosed herein, the first and second set of packets can have different numbers of different packets. For example, the first set can include 4 packets with different mixtures of one or more spices and one or more vegetables and the second set can include 6 packets with different sources of carbohydrates.

In some embodiments, the one or more vegetables can include any vegetable. In illustrative embodiments, the one or more vegetables can include green peppers, red peppers, green bell pepper, red bell pepper yellow peppers, beans, green beans, bean sprouts, refried beans, onions, peas, water chestnuts, celery, carrots, corn, whole kernel sweet corn, potatoes, green leeks, white leeks, kale, and/or tomatoes. In some embodiments, the vegetables can be whole vegetables of one or more varieties, or sliced vegetables having a volume of at least 1/100, 1/90, 1/80, 1/70, 1/60, 1/50, 1/40, 1/30, 1/25, 1/20, 1/15, 1/10, 1/9, ⅛, 1/7, ⅙, ⅕, ¼, ⅓, or ½ the volume of the whole vegetable from which the sliced vegetable was prepared (i.e. corresponding whole vegetable). In some embodiments, the volume of the whole vegetable can be a volume typical for the whole vegetable or for sliced vegetables can be at least 0.25 cm³, 0.5 cm³, 0.75 cm³, 1 cm³, 1.25 cm³, 1.5 cm³, or 2 cm³ up to ½ the volume of the whole vegetable from which the sliced vegetable was prepared. In some embodiments, the one or more vegetables can be parboiled or pre-cooked before being placed or sealed in the packet. In some embodiments, after heating, the one or more vegetables can be identifiable visually to a consumer of the one or more vegetables. In other words, a person looking at the vegetable after the meal is prepared using a method disclosed herein, in illustrative embodiments can identify the vegetable. One of the advantages of the methods provided herein is that meals prepared using these methods have an appearance similar to freshly prepared meals. In some embodiments, after heating, each of the one or more vegetables can be visually indistinguishable from a fresh sample of each of the same one or more vegetables to a person consuming the meal. In some embodiments, after heating, the one or more vegetables can be visually appealing. Whereas many prior methods for preparing pre-packaged foods result in meals that look different than freshly prepared meals, meals provided using illustrative methods herein have an appearance that looks more similar to a freshly prepared meal than to a prepared frozen food. In some embodiments, after heating, each of the one or more vegetables can be the color or close to the color of a fresh sample of each of the same one or more vegetables.

In some embodiments, the one or more sources of carbohydrates can contain simple carbohydrates or complex carbohydrates. In some embodiments, the one or more sources of carbohydrates can be whole-grain and/or refined and/or processed. In illustrative embodiments, the one or more sources of carbohydrates can be whole-grain. In some embodiments, the carbohydrates can be quick cooking. In some embodiments, the one or more sources of carbohydrates can include pasta, beans, rice, lentils, peas, and/or quinoa. In illustrative embodiments, the one or more source of carbohydrates can be edamame pasta, buckwheat pasta, whole-wheat couscous, brown rice pasta, Kamut pasta, quinoa pasta, spelt pasta, or corn pasta. In some embodiments, the pasta can include fusilli, spaghetti, vermicelli, ziti, fettuccine, lasagna, pappardelle, tagliatelle, taglierini, cannelloni, macaroni, manicotti, penne, rigatoni, rotini, spirali, farfalle, gnocchi, rotelle, orzo, ravioli, tortellini, angel hair, maltagliati, and spatzle. In some embodiments, the beans can include adzuki beans, Anasazi beans, black beans, black-eyed peas, borlotti beans, butter beans, cannellini beans, lima beans, corona beans, fava beans, flageolet beans, garbanzo beans, Bengal gram chickpeas, Chana Dal chickpeas, Great Northern beans, kidney beans, lentils, green lentils, red lentils, yellow lentils, brown lentils, lima beans, lupini beans, mung beans, navy beans, pigeon pea, pink beans, pinto beans, red beans, rice beans, scarlet runner beans, soybean, soya bean, Spanish Tolosana beans, split green peas, split yellow peas, Tepary beans, and/or urad beans. In some embodiments, the rice can include brown rice, Wehani rice, Basmati rice, Himalayan Red rice, Colusari Red rice, purple Thai rice, Chinese Black rice, jasmine rice, Arborio rice, matta rice, rosematta rice, red cargo rice, sticky rice, sushi rice, Valencia rice, wild rice, and/or white rice. In some embodiments, the rice can be short, medium, or long grain rice.

In some embodiments, the one or more spices can be fresh, dried, whole, ground, or chopped. In some embodiments, the one or more spices can include sage, ancho pepper, coriander seeds, parsley, granulated garlic, mustard seeds, fennel seed, cumin, basil, cinnamon, bay leaves, paprika, smoked paprika, thyme, garlic powder, oregano, onion powder, rosemary, nutmeg, red pepper flakes, coriander, cayenne pepper, clove, Chinese five spice, turmeric, curry powder, yellow mustard, pepper, cardamom, Cajun seasoning, allspice, chili powder, and/or ginger root. In some embodiments, the one or more spices can be in a separate third packet that does not include the one or more vegetables.

In some embodiments, the method can include selecting a third or fourth packet that can include a pre-portioned amount of one or more sources of protein. In some embodiments, the sources of protein can be a powder, dried, whole, or sliced protein. In some embodiments, the one or more sources of protein can be derived from plant protein or animal protein. In some embodiments, the plant protein can include protein from peas, hemp, soy, cranberries, rice, amaranth, quinoa, millet, pumpkin seeds, alfalfa, chia seeds, flaxseeds, or artichoke. In some embodiments, the animal protein can include protein from whey, casein, or eggs. In some embodiments, the animal protein can include protein from cows, pigs, sheep, goat, deer, or bison. In illustrative embodiments, the one or more sources of protein can be powders and can include protein from casein or peas. In some embodiments, the pre-portioned amount of one or more sources of protein can be included in the first or second packet. In some embodiments, any of the packets or set of packets can be the first packet or first set of packets, any of the packets or set of packets can be the second packet or second set of packets, any of the packets or set of packets can be the third packet or third set of packets, and any of the packets or set of packets can be the fourth packet or fourth set of packets and do not indicate a specific order. For example, the first set of packets can include the carbohydrate packets and the second set of packets can include the spice-vegetable packets.

In some embodiments, the meal and/or one, some, or all of the packets can be prepared according to various standards. In some embodiments, the meal and/or one, some, or all of the packets can be sodium-free, salt-free, very low sodium, low sodium, reduced sodium, and/or less sodium. In some embodiments, the meal and/or one, some, or all of the packets do not include extra, additional, or supplemental sodium. In some embodiments, the meal and/or one, some, or all of the packets can include potassium chloride. In some embodiments, the meal and/or one, some, or all of the packets can be fat free, low fat, reduced fat, and/or less fat. In some embodiments, the meal and/or one, some, or all of the packets can have a low glycemic index. In some embodiments, the meal and/or one, some, or all the packets can have a medium glycemic index.

In some embodiments, the meal and/or one, some, or all of the packets do not include food coloring. In some embodiments, the one or more vegetables and/or the one or more sources of carbohydrates and/or the one or more spices and/or the one or more sources of protein have not been contacted with food coloring and/or the coloring has not been adjusted artificially. In some embodiments, the meal and/or one, some, or all of the packets do not include artificial preservatives. In some embodiments, the one or more vegetables and/or the one or more sources of carbohydrates and/or the one or more spices and/or the one or more sources of protein have not been contacted with artificial preservatives. Furthermore, in some embodiments the meal and/or one, some, or all of the packets do not include an ingredient made from a genetically-modified organism. In addition, in some embodiments the meal and/or one, some, or all of the packets are gluten-free and/or made from organic sources.

In some embodiments, 1, 2, 3, 4, 5, 6, 7, 8, 9, 10, 11, 12, 13, 14, 15, 20, 24 or more, or some, or in illustrative embodiments all of the packets used in a method or meal kit, or enclosure provided herein, are sealed, such as hermitically sealed. In some embodiments, the packets can be sealed under vacuum. In some embodiments, the packets can be sealed in a manner that can be opened by hand. In some embodiments, the packets can be made of plastic. In some embodiments, the packets can be sealed in reusable, re-sealable bags, for example using a plastic zipper. In some embodiments, the packets can be shelf-stable for at least 7, 14, 21, or 28 days or 1, 2, 3, 4, 5, 6, 7, 8, 9, 10, 11, 12, 15, 18, 21, 24, 30, 36, 42, 48, or 60 months or for up to 2, 3, 6, 12, 15, 18, 21, 24, 30, 36, 42, 48, 60, 72, or 84 months at room temperature or about 25° C.

In some embodiments, the moisture content of the packets can be less than 1%, 2%, 3%, 4%, 5%, 10%, 15%, or 20%. In some embodiments, the one or more vegetables and/or the one or more sources of carbohydrates and/or the one or more spices and/or the one or more sources of protein can be air-dried and not subjected to a temperature below 0° C. In some embodiments, the one or more vegetables and/or the one or more sources of carbohydrates and/or the one or more spices and/or the one or more sources of protein can be exposed to temperatures of at least 1° C., 2° C., 3° C., 4° C., 5° C., 6° C., 7° C., 8° C., 9° C., 10° C., 15° C., 20° C., 25° C., 30° C., 32° C., 35° C., 40° C., 42° C., or 45° C. during air drying. In some embodiments, the one or more vegetables and/or the one or more sources of carbohydrates and/or the one or more spices and/or the one or more sources of protein can be exposed to temperatures between 1° C., 2° C., 3° C., 4° C., 5° C., 6° C., 7° C., 8° C., 9° C., 10° C., 15° C., 20° C., and 25° C. during air drying on the low end of the range and 5° C., 6° C., 7° C., 8° C., 9° C., 10° C., 15° C., 20° C., 25° C., 30° C., 35° C., 40° C., 42° C., and 45° C. during air drying on the high end of the range.

In any of the embodiments disclosed herein, the selecting can be performed, for example, using an order selection function, such as an order selection means, such as an online interactive system, a computer program such as a software application run on a computer system, such as a wide area network or a local area network using a computer server, or a personal computer, or on a portable computer device such as a computer tablet or a cellular phone, a vending machine, or a self-service machine which optionally is connected to a computer or cellular network, or the selecting can be performed manually using any means for selecting including a display box including multiple compartments. In illustrative embodiments, the selecting can include a user interface with the capacity for the user to individually select each of the one or more vegetables, each of the one or more spices, each of the sources of carbohydrates, and, optionally, each of the one or more sources of protein. In some embodiments, all of the steps can be performed within a machine. In illustrative embodiments, the selection of spices can include 2, 3, 4, 5, 6, 7, 8, 9, 10, 15, 20, or 25 spice blends, wherein each spice blend can include one or more spices. In further illustrative embodiments, the selection can include 2, 3, 4, or 5 spice blends.

In any of the embodiments disclosed herein, the method can be performed in a vehicle traveling in the atmosphere or in outer space. In some embodiments, the vehicle can be an airplane, spaceship, or space station. In some embodiments, the method can be performed on a planetary body other than Earth.

In some embodiments, the method of preparing the meal can further include choosing between at least 2, 3, 4, 5, 6, 7, 8, 9, 10, 11, 12, 13, 14, 15, 16, 20, 24, 36, or 48 combinations of packets, wherein at least 1, 2, or 3 of the first and second and the optional third and fourth packets are not added to the meal. In some embodiments, the mixture can be heated for different times depending on what combination of packets are chosen. In some embodiments, the mixture can be allowed to sit in the container for different times depending on what combination of packets are chosen. In illustrative embodiments, the food can be heated or sit in a closed or loosely covered container.

In another aspect, provided herein is an enclosure including: a first set of packets, wherein each packet of the first set of packets is a sealed packet including a pre-portioned amount of a different mixture of one or more spices and one or more vegetables, wherein the vegetables are whole or sliced vegetables having a volume at least 1/20 the volume of the whole vegetable and/or wherein the vegetables have been air dried and/or have not been subjected to a temperature below 0° C.; and a second set of packets, wherein each packet of the second set of packets includes a pre-portioned amount of one or more sources of carbohydrates, wherein the package includes at least 6 total packets including the first set of packets and the second set of packets. In some embodiments, the enclosure can be a cardboard, plastic, or metal box. In other embodiments, the enclosure can be a vending machine. In some embodiments, the enclosure can be a box that is less than 4, 6, 8, or 10 inches, or 1 or 2 feet wide, less than 4, 6, 8, or 10 inches, or 1 or 2 feet tall, and less than 4, 6, 8, or 10 inches, or 1 or 2 feet long. In some embodiments, the box is of a size that is easily shipped to a consumer at a residence and stored in a kitchen.

In some embodiments, the first set of packets can include at least 2, 3, 4, 5, 6, 7, 8, 9, or 10 packets with different mixtures of one or more spices and one or more vegetables and the second set of packets can include at least t 2, 3, 4, 5, 6, 7, 8, 9, or 10 packets with different sources of carbohydrates.

In some embodiments, the one or more vegetables can include any vegetable. In illustrative embodiments, the one or more vegetables can include green peppers, red peppers, green bell pepper, red bell pepper yellow peppers, beans, green beans, bean sprouts, refried beans, onions, peas, water chestnuts, celery, carrots, corn, whole kernel sweet corn, potatoes, green leeks, white leeks, kale, and/or tomatoes. In some embodiments, the vegetables can be whole or sliced and have a volume of at least 1/100, 1/90, 1/80, 1/70, 1/60, 1/50, 1/40, 1/30, 1/25, 1/20, 1/15, 1/10, 1/9, ⅛, 1/7, ⅙, ⅕, ¼, ⅓, or ½ the volume of the whole vegetable from which the sliced vegetable was prepared. In some embodiments, the volume of the whole or sliced vegetables can be at least 0.25 cm³, 0.5 cm³, 0.75 cm³, 1 cm³, 1.25 cm³, 1.5 cm³, or 2 cm³. In some embodiments, the one or more vegetables can be parboiled or pre-cooked before being placed or sealed in the packet. In some embodiments, after heating, the one or more vegetables can be identifiable visually for example to a consumer of the one or more vegetables. In some embodiments, after heating, each of the one or more vegetables can be visually indistinguishable from a fresh sample of each of the same one or more vegetables for example to a consumer of the one or more vegetables. In some embodiments, after heating, the one or more vegetables can be visually appealing. In some embodiments, after heating, each of the one or more vegetables can be the color or close to the color of a fresh sample of each of the same one or more vegetables.

In some embodiments, the one or more sources of carbohydrates can contain simple carbohydrates or complex carbohydrates. In some embodiments, the one or more sources of carbohydrates can be whole-grain and/or refined and/or processed. In illustrative embodiments, the one or more sources of carbohydrates can be whole-grain. In some embodiments, the carbohydrates can be quick cooking. In some embodiments, the one or more sources of carbohydrates can include pasta, beans, rice, lentils, peas, and/or quinoa. In illustrative embodiments, the one or more source of carbohydrates can be edamame pasta, buckwheat pasta, whole-wheat couscous, brown rice pasta, Kamut pasta, quinoa pasta, spelt pasta, or corn pasta. In some embodiments, the pasta can include fusilli, spaghetti, vermicelli, ziti, fettuccine, lasagna, pappardelle, tagliatelle, taglierini, cannelloni, macaroni, manicotti, penne, rigatoni, rotini, spirali, farfalle, gnocchi, rotelle, orzo, ravioli, tortellini, angel hair, maltagliati, and spatzle. In some embodiments, the beans can include adzuki beans, Anasazi beans, black beans, black-eyed peas, borlotti beans, butter beans, cannellini beans, lima beans, corona beans, fava beans, flageolet beans, garbanzo beans, Bengal gram chickpeas, Chana Dal chickpeas, Great Northern beans, kidney beans, lentils, green lentils, red lentils, yellow lentils, brown lentils, lima beans, lupini beans, mung beans, navy beans, pigeon pea, pink beans, pinto beans, red beans, rice beans, scarlet runner beans, soybean, soya bean, Spanish Tolosana beans, split green peas, split yellow peas, Tepary beans, and/or urad beans. In some embodiments, the rice can include brown rice, Wehani rice, Basmati rice, Himalayan Red rice, Colusari Red rice, purple Thai rice, Chinese Black rice, jasmine rice, Arborio rice, matta rice, rosematta rice, red cargo rice, sticky rice, sushi rice, Valencia rice, wild rice, and/or white rice. In some embodiments, the rice can be short, medium, or long grain rice.

In some embodiments, the one or more spices can be fresh, dried, whole, ground, or chopped. In some embodiments, the one or more spices can include sage, ancho pepper, coriander seeds, parsley, granulated garlic, mustard seeds, fennel seed, cumin, basil, cinnamon, bay leaves, paprika, smoked paprika, thyme, garlic powder, oregano, onion powder, rosemary, nutmeg, red pepper flakes, coriander, cayenne pepper, clove, Chinese five spice, turmeric, curry powder, yellow mustard, pepper, cardamom, Cajun seasoning, allspice, chili powder, and/or ginger root. In some embodiments, the one or more spices can be in a separate third packet that does not include the one or more vegetables.

In some embodiments, the enclosure can include a third or fourth packet that can include a pre-portioned amount of one or more sources of protein. In some embodiments, the sources of protein can be a powder, dried, whole, or sliced protein. In some embodiments, the one or more sources of protein can be derived from plant protein or animal protein. In some embodiments, the plant protein can include protein from peas, hemp, soy, cranberries, rice, amaranth, quinoa, millet, pumpkin seeds, alfalfa, chia seeds, flaxseeds, or artichoke. In some embodiments, the animal protein can include protein from whey, casein, or eggs. In some embodiments, the animal protein can include protein from cows, pigs, sheep, goat, deer, or bison. In illustrative embodiments, the one or more sources of protein can be powders and can include protein from casein or peas. In some embodiments, the pre-portioned amount of one or more sources of protein can be included in the first or second packet. In some embodiments, any of the packets or set of packets can be the first packet or first set of packets, any of the packets or set of packets can be the second packet or second set of packets, any of the packets or set of packets can be the third packet or third set of packets, and any of the packets or set of packets can be the fourth packet or fourth set of packets and do not indicate a specific order. For example, the first set of packets can include the carbohydrate packets and the second set of packets can include the spice-vegetable packets.

In some embodiments, the enclosure and/or one, some, or all of the packets can be prepared according to various standards. In some embodiments, the enclosure and/or one, some, or all of the packets can be sodium-free, salt-free, very low sodium, low sodium, reduced sodium, and/or less sodium. In some embodiments, the enclosure and/or one, some, or all of the packets do not include extra, additional, or supplemental sodium. In some embodiments, the enclosure and/or one, some, or all of the packets can include potassium chloride. In some embodiments, the enclosure and/or one, some, or all of the packets can be fat free, low fat, reduced fat, and/or less fat. In some embodiments, the enclosure and/or one, some, or all of the packets can have a low glycemic index. In some embodiments, the enclosure and/or one, some, or all the packets can have a medium glycemic index.

In some embodiments, the enclosure and/or one, some, or all of the packets do not include food coloring. In some embodiments, the one or more vegetables and/or the one or more sources of carbohydrates and/or the one or more spices and/or the one or more sources of protein have not been contacted with food coloring and/or the coloring has not been adjusted artificially. In some embodiments, the enclosure and/or one, some, or all of the packets do not include artificial preservatives. In some embodiments, the one or more vegetables and/or the one or more sources of carbohydrates and/or the one or more spices and/or the one or more sources of protein have not been contacted with artificial preservatives.

In some embodiments, the packets can be hermitically sealed. In some embodiments, the packets can be sealed under vacuum. In some embodiments, the packets can be sealed in a manner that can be opened by hand. In some embodiments, the packets can be made of plastic. In some embodiments, the packets can be sealed in reusable, re-sealable bags, for example using a plastic zipper. In some embodiments, the packets can be shelf-stable for at least 7, 14, 21, or 28 days or 1, 2, 3, 4, 5, 6, 7, 8, 9, 10, 11, 12, 15, 18, 21, 24, 30, 36, 42, 48, or 60 months at room temperature or about 25° C.

In some embodiments, the moisture content of the packets can be less than 1%, 2%, 3%, 4%, 5%, 10%, 15%, or 20%. In some embodiments, the one or more vegetables and/or the one or more sources of carbohydrates and/or the one or more spices and/or the one or more sources of protein can be air-dried and/or not subjected to a temperature below 0° C. In some embodiments, the one or more vegetables and/or the one or more sources of carbohydrates and/or the one or more spices and/or the one or more sources of protein can be exposed to temperatures of at least 1° C., 2° C., 3° C., 4° C., 5° C., 6° C., 7° C., 8° C., 9° C., 10° C., 15° C., 20° C., 25° C., 30° C., 32° C., 35° C., 40° C., 42° C., or 45° C. during air drying. In some embodiments, the one or more vegetables and/or the one or more sources of carbohydrates and/or the one or more spices and/or the one or more sources of protein can be exposed to temperatures between 1° C., 2° C., 3° C., 4° C., 5° C., 6° C., 7° C., 8° C., 9° C., 10° C., 15° C., 20° C., and 25° C. during air drying on the low end of the range and 5° C., 6° C., 7° C., 8° C., 9° C., 10° C., 15° C., 20° C., 25° C., 30° C., 35° C., 40° C., 42° C., and 45° C. during air drying on the high end of the range.

In some embodiments, the enclosure can further include instructions for preparing a meal based on which packets are in the enclosure. In some embodiments, the instructions can include different methods of preparation dependent on various combinations of the packets in the enclosure. In some embodiments, the method of preparation can include combining the contents of a packet including the one or more spices and the one or more vegetables and the contents of a packet including the one or more sources of carbohydrates into a volume of water to form a mixture. In some embodiments, the mixture can be heated under conditions to cook the mixture for no more than 5 minutes in a microwave oven and allowing to sit in a container for no less than 5 minutes thereafter. In illustrative embodiments, the container can be closed or loosely covered. In some embodiments, the mixture can be heated for no more than 1, 2, 3, 4, 5, 6, 7, 8, 9, or 10 minutes. In some embodiments, the mixture can be allowed to sit in a container for no less than 1, 2, 3, 4, 5, 6, 7, 8, 9, or 10 minutes before or especially after heating. In some embodiments, especially those that include quinoa, the mixture can be allowed to sit for at least about 10, 11, 12, 13, 14 and preferably at least 15 minutes after heating. In some embodiments, the mixture can be heated for different times depending on what combination of packets are chosen. In some embodiments, the mixture can be allowed to sit in the container for different times depending on what combination of packets are chosen.

In another aspect, provided herein is a meal kit for preparing at least two distinct hot meals, said meal kit includes an outer container and a plurality of packets located within the outer container, wherein the plurality of packets includes: a first set of packets, wherein each packet of the first set of packets is a sealed packet that includes a pre-portioned amount of a mixture of one or more spices and one or more vegetables, wherein the vegetables are whole or sliced vegetables having a volume at least 1/20 the volume of the whole vegetable, and wherein the vegetables have been air dried and/or have not been subjected to a temperature below 0° C. The meal kit further includes a second set of packets, wherein each packet of the second set of packets includes a pre-portioned amount of one or more sources of carbohydrates, wherein the meal kit includes at least total 6 packets including the first set of packets and the second set of packets.

Variety is important for encouraging selection of healthy foods. In some embodiments, the first set of packets can include at least 2, 3, 4, 5, 6, 7, 8, 9, or 10 packets with different mixtures of one or more spices and one or more vegetables. In some embodiments, the second set of packets can include at least 2, 3, 4, 5, 6, 7, 8, 9, or 10 packets with different sources of carbohydrates. In any of the embodiments disclosed herein, the first and second set of packets can have different numbers of different packets. For example, the first set can include 4 packets with different mixtures of one or more spices and one or more vegetables and the second set can include 6 packets with different sources of carbohydrates.

In some embodiments, the one or more vegetables can include any vegetable. In illustrative embodiments, the one or more vegetables can include green peppers, red peppers, green bell pepper, red bell pepper yellow peppers, beans, green beans, bean sprouts, refried beans, onions, peas, water chestnuts, celery, carrots, corn, whole kernel sweet corn, potatoes, green leeks, white leeks, kale, and/or tomatoes. In some embodiments, the vegetables can be whole or sliced and have a volume of at least 1/100, 1/90, 1/80, 1/70, 1/60, 1/50, 1/40, 1/30, 1/25, 1/20, 1/15, 1/10, 1/9, ⅛, 1/7, ⅙, ⅕, ¼, ⅓, or ½ the volume of the whole vegetable. In some embodiments, the volume of the whole or sliced vegetables can be at least 0.25 cm³, 0.5 cm³, 0.75 cm³, 1 cm³, 1.25 cm³, 1.5 cm³, or 2 cm³. In some embodiments, the one or more vegetables can be parboiled or pre-cooked before being placed or sealed in the packet. In some embodiments, after heating, the one or more vegetables can be identifiable visually. In other words, a person looking at the vegetable after a meal is prepared using the meal kit, in illustrative embodiments can identify the vegetable. One of the advantages of the meal kits provided herein is that meals prepared using these meal kits have an appearance similar to freshly prepared meals. In some embodiments, after heating, each of the one or more vegetables can be visually indistinguishable from a fresh sample of each of the same one or more vegetables to a person consuming the meal. In some embodiments, after heating, the one or more vegetables can be visually appealing. In some embodiments, after heating, each of the one or more vegetables can be the color or close to the color of a fresh sample of each of the same one or more vegetables.

In some embodiments, the one or more sources of carbohydrates can contain simple carbohydrates or complex carbohydrates. In some embodiments, the one or more sources of carbohydrates can be whole-grain and/or refined and/or processed. In illustrative embodiments, the one or more sources of carbohydrates can be whole-grain. In some embodiments, the carbohydrates can be quick cooking. In some embodiments, the one or more sources of carbohydrates can include pasta, beans, rice, lentils, peas, and/or quinoa. In illustrative embodiments, the one or more source of carbohydrates can be edamame pasta, buckwheat pasta, whole-wheat couscous, brown rice pasta, Kamut pasta, quinoa pasta, spelt pasta, or corn pasta. In some embodiments, the pasta can include fusilli, spaghetti, vermicelli, ziti, fettuccine, lasagna, pappardelle, tagliatelle, taglierini, cannelloni, macaroni, manicotti, penne, rigatoni, rotini, spirali, farfalle, gnocchi, rotelle, orzo, ravioli, tortellini, angel hair, maltagliati, and spatzle. In some embodiments, the beans can include adzuki beans, Anasazi beans, black beans, black-eyed peas, borlotti beans, butter beans, cannellini beans, lima beans, corona beans, fava beans, flageolet beans, garbanzo beans, Bengal gram chickpeas, Chana Dal chickpeas, Great Northern beans, kidney beans, lentils, green lentils, red lentils, yellow lentils, brown lentils, lima beans, lupini beans, mung beans, navy beans, pigeon pea, pink beans, pinto beans, red beans, rice beans, scarlet runner beans, soybean, soya bean, Spanish Tolosana beans, split green peas, split yellow peas, Tepary beans, and/or urad beans. In some embodiments, the rice can include brown rice, Wehani rice, Basmati rice, Himalayan Red rice, Colusari Red rice, purple Thai rice, Chinese Black rice, jasmine rice, Arborio rice, matta rice, rosematta rice, red cargo rice, sticky rice, sushi rice, Valencia rice, wild rice, and/or white rice. In some embodiments, the rice can be short, medium, or long grain rice.

In some embodiments, the one or more spices can be fresh, dried, whole, ground, or chopped. In some embodiments, the one or more spices can include sage, ancho pepper, coriander seeds, parsley, granulated garlic, mustard seeds, fennel seed, cumin, basil, cinnamon, bay leaves, paprika, smoked paprika, thyme, garlic powder, oregano, onion powder, rosemary, nutmeg, red pepper flakes, coriander, cayenne pepper, clove, Chinese five spice, turmeric, curry powder, yellow mustard, pepper, cardamom, Cajun seasoning, allspice, chili powder, and/or ginger root. In some embodiments, the one or more spices can be in a separate third packet that does not include the one or more vegetables.

In some embodiments, the outer container of the meal kit, further includes a microwaveable container. The microwaveable container is typically a size that is appropriate for preparing a meal using the meal kit. In some embodiments, the outer container is a microwaveable container. The microwaveable container can be, for example, an appropriate size for a 1, 2, 3, 4, or 5 serving meal. In illustrative embodiments, the microwaveable container is appropriate for a 1 200, 400, or 600 g serving meal.

In some embodiments, a meal from the meal kit can be prepared (or a method for preparing a meal provided herein can be performed), in 15 minutes or less or 10 minutes or less. In some embodiments, a meal from the meal kit can be prepared (or a method for preparing a meal provided herein can be performed) and is easy to prepare in that they can be prepared by a person who has the equivalent of a 4^{th}, 3^{rd}, 2^{nd} or 1^{st} grade education or by a person who is unable to read and/or write due to lack of education, due to age, due to health, and/or due to disability. In some embodiments, at least 90% or all of the meals that can be prepared using the meal kit and/or method provided herein are low sodium, low fat, and/or have a shelf-life of greater than 6 months. In some embodiments, at least 90% or all of the meals that can be prepared using the meal kit and/or method provided herein are lower sodium than a can of regular Campbell's chicken noodle soup or lower than 140 mg of sodium per serving, lower than 3 g of fat per serving, and/or have a shelf-life of greater than 6 months.

In some embodiments, the outer container can include a third or fourth packet that can include a pre-portioned amount of one or more sources of protein. In some embodiments, the sources of protein can be a powder, dried, whole, or sliced protein. In some embodiments, the one or more sources of protein can be derived from plant protein or animal protein. In some embodiments, the plant protein can include protein from peas, hemp, soy, cranberries, rice, amaranth, quinoa, millet, pumpkin seeds, alfalfa, chia seeds, flaxseeds, or artichoke. In some embodiments, the animal protein can include protein from whey, casein, or eggs. In some embodiments, the animal protein can include protein from cows, pigs, sheep, goat, deer, or bison. In illustrative embodiments, the one or more sources of protein can be powders and can include protein from casein or peas. In some embodiments, the pre-portioned amount of one or more sources of protein can be included in the first or second packet. In some embodiments, any of the packets or set of packets can be the first packet or first set of packets, any of the packets or set of packets can be the second packet or second set of packets, any of the packets or set of packets can be the third packet or third set of packets, and any of the packets or set of packets can be the fourth packet or fourth set of packets and do not indicate a specific order. For example, the first set of packets can include the carbohydrate packets and the second set of packets can include the spice-vegetable packets.

In some embodiments, the meal kit and/or one, some, or all of the packets can be prepared according to various standards. In some embodiments, the meal kit and/or one, some, or all of the packets can be sodium-free, salt-free, very low sodium, low sodium, reduced sodium, and/or less sodium. In some embodiments, the meal kit and/or one, some, or all of the packets do not include extra, additional, or supplemental sodium. In some embodiments, the meal kit and/or one, some, or all of the packets can include potassium chloride. In some embodiments, the meal kit and/or one, some, or all of the packets can be fat free, low fat, reduced fat, and/or less fat. In some embodiments, the meal kit and/or one, some, or all of the packets can have a low glycemic index. In some embodiments, the meal kit and/or one, some, or all the packets can have a medium glycemic index.

In some embodiments, the meal kit and/or one, some, or all of the packets do not include food coloring. In some embodiments, the one or more vegetables and/or the one or more sources of carbohydrates and/or the one or more spices and/or the one or more sources of protein have not been contacted with food coloring and/or the coloring has not been adjusted artificially. In some embodiments, the meal kit and/or one, some, or all of the packets do not include artificial preservatives. In some embodiments, the one or more vegetables and/or the one or more sources of carbohydrates and/or the one or more spices and/or the one or more sources of protein have not been contacted with artificial preservatives.

In some embodiments, the packets can be hermitically sealed. In some embodiments, the packets can be sealed under vacuum. In some embodiments, the packets can be sealed in a manner that can be opened by hand. In some embodiments, the packets can be made of plastic. In some embodiments, the packets can be sealed in reusable, re-sealable bags, for example using a plastic zipper. In some embodiments, the packets can be shelf-stable for at least 7, 14, 21, or 28 days or 1, 2, 3, 4, 5, 6, 7, 8, 9, 10, 11, 12, 15, 18, 21, 24, 30, 36, 42, 48, or 60 months at room temperature or about 25° C.

In some embodiments, the moisture content of the packets can be less than 1%, 2%, 3%, 4%, 5%, 10%, 15%, or 20%. In some embodiments, the one or more vegetables and/or the one or more sources of carbohydrates and/or the one or more spices and/or the one or more sources of protein can be air-dried and not subjected to a temperature below 0° C. In some embodiments, the one or more vegetables and/or the one or more sources of carbohydrates and/or the one or more spices and/or the one or more sources of protein can be exposed to temperatures of at least 1° C., 2° C., 3° C., 4° C., 5° C., 6° C., 7° C., 8° C., 9° C., 10° C., 15° C., 20° C., 25° C., 30° C., 32° C., 35° C., 40° C., 42° C., or 45° C. during air drying. In some embodiments, the one or more vegetables and/or the one or more sources of carbohydrates and/or the one or more spices and/or the one or more sources of protein can be exposed to temperatures between 1° C., 2° C., 3° C., 4° C., 5° C., 6° C., 7° C., 8° C., 9° C., 10° C., 15° C., 20° C., and 25° C. during air drying on the low end of the range and 5° C., 6° C., 7° C., 8° C., 9° C., 10° C., 15° C., 20° C., 25° C., 30° C., 35° C., 40° C., 42° C., and 45° C. during air drying on the high end of the range.

In another aspect, provided herein is a self-service machine for selecting a meal, including a) presenting a first set of packets, wherein each packet of the first set of packets is a sealed packet including a pre-portioned amount of a mixture of one or more spices and one or more vegetables, wherein the vegetables are whole or sliced vegetables having a volume at least 1/20 the volume of the whole vegetable, and wherein the vegetables have been air dried and/or have not been subjected to a temperature below 0° C. The self-service machine further includes b) presenting a second set of packets, wherein each packet of the second set of packets includes a pre-portioned amount of one or more sources of carbohydrates. The self-service machine further includes c) providing a functionality for selecting a first packet from the first set of packets, and a second packet from the second set of packets, thereby selecting the meal.

Variety is important for encouraging selection of healthy foods. In some embodiments, the first set of packets can include at least 2, 3, 4, 5, 6, 7, 8, 9, or 10 packets with different mixtures of one or more spices and one or more vegetables. In some embodiments, the second set of packets can include at least 2, 3, 4, 5, 6, 7, 8, 9, or 10 packets with different sources of carbohydrates. In any of the embodiments disclosed herein, the first and second set of packets can have different numbers of different packets. For example, the first set can include 4 packets with different mixtures of one or more spices and one or more vegetables and the second set can include 6 packets with different sources of carbohydrates.

In some embodiments, the one or more vegetables can include any vegetable. In illustrative embodiments, the one or more vegetables can include green peppers, red peppers, green bell pepper, red bell pepper yellow peppers, beans, green beans, bean sprouts, refried beans, onions, peas, water chestnuts, celery, carrots, corn, whole kernel sweet corn, potatoes, green leeks, white leeks, kale, and/or tomatoes. In some embodiments, the vegetables can be whole or sliced and have a volume of at least 1/100, 1/90, 1/80, 1/70, 1/60, 1/50, 1/40, 1/30, 1/25, 1/20, 1/15, 1/10, 1/9, ⅛, 1/7, ⅙, ⅕, ¼, ⅓, or ½ the volume of the whole vegetable. In some embodiments, the volume of the whole or sliced vegetables can be at least 0.25 cm³, 0.5 cm³, 0.75 cm³, 1 cm³, 1.25 cm³, 1.5 cm³, or 2 cm³. In some embodiments, the one or more vegetables can be parboiled or pre-cooked before being placed or sealed in the packet. In some embodiments, after heating, the one or more vegetables can be identifiable visually. In other words, a person looking at the vegetable after the meal is prepared using a method disclosed herein, in illustrative embodiments can identify the vegetable. One of the advantages of the packets provided herein is that meals prepared using these packets have an appearance similar to freshly prepared meals. In some embodiments, after heating, each of the one or more vegetables can be visually indistinguishable from a fresh sample of each of the same one or more vegetables to a person consuming the meal. In some embodiments, after heating, the one or more vegetables can be visually appealing. In some embodiments, after heating, each of the one or more vegetables can be the color or close to the color of a fresh sample of each of the same one or more vegetables.

In some embodiments, the one or more sources of carbohydrates can contain simple carbohydrates or complex carbohydrates. In some embodiments, the one or more sources of carbohydrates can be whole-grain and/or refined and/or processed. In illustrative embodiments, the one or more sources of carbohydrates can be whole-grain. In some embodiments, the carbohydrates can be quick cooking. In some embodiments, the one or more sources of carbohydrates can include pasta, beans, rice, lentils, peas, and/or quinoa. In illustrative embodiments, the one or more source of carbohydrates can be edamame pasta, buckwheat pasta, whole-wheat couscous, brown rice pasta, Kamut pasta, quinoa pasta, spelt pasta, or corn pasta. In some embodiments, the pasta can include fusilli, spaghetti, vermicelli, ziti, fettuccine, lasagna, pappardelle, tagliatelle, taglierini, cannelloni, macaroni, manicotti, penne, rigatoni, rotini, spirali, farfalle, gnocchi, rotelle, orzo, ravioli, tortellini, angel hair, maltagliati, and spatzle. In some embodiments, the beans can include adzuki beans, Anasazi beans, black beans, black-eyed peas, borlotti beans, butter beans, cannellini beans, lima beans, corona beans, fava beans, flageolet beans, garbanzo beans, Bengal gram chickpeas, Chana Dal chickpeas, Great Northern beans, kidney beans, lentils, green lentils, red lentils, yellow lentils, brown lentils, lima beans, lupini beans, mung beans, navy beans, pigeon pea, pink beans, pinto beans, red beans, rice beans, scarlet runner beans, soybean, soya bean, Spanish Tolosana beans, split green peas, split yellow peas, Tepary beans, and/or urad beans. In some embodiments, the rice can include brown rice, Wehani rice, Basmati rice, Himalayan Red rice, Colusari Red rice, purple Thai rice, Chinese Black rice, jasmine rice, Arborio rice, matta rice, rosematta rice, red cargo rice, sticky rice, sushi rice, Valencia rice, wild rice, and/or white rice. In some embodiments, the rice can be short, medium, or long grain rice.

In some embodiments, the one or more spices can be fresh, dried, whole, ground, or chopped. In some embodiments, the one or more spices can include sage, ancho pepper, coriander seeds, parsley, granulated garlic, mustard seeds, fennel seed, cumin, basil, cinnamon, bay leaves, paprika, smoked paprika, thyme, garlic powder, oregano, onion powder, rosemary, nutmeg, red pepper flakes, coriander, cayenne pepper, clove, Chinese five spice, turmeric, curry powder, yellow mustard, pepper, cardamom, Cajun seasoning, allspice, chili powder, and/or ginger root. In some embodiments, the one or more spices can be in a separate third packet that does not include the one or more vegetables.

In some embodiments, the method can include selecting a third or fourth packet that can include a pre-portioned amount of one or more sources of protein. In some embodiments, the sources of protein can be a powder, dried, whole, or sliced protein. In some embodiments, the one or more sources of protein can be derived from plant protein or animal protein. In some embodiments, the plant protein can include protein from peas, hemp, soy, cranberries, rice, amaranth, quinoa, millet, pumpkin seeds, alfalfa, chia seeds, flaxseeds, or artichoke. In some embodiments, the animal protein can include protein from whey, casein, or eggs. In some embodiments, the animal protein can include protein from cows, pigs, sheep, goat, deer, or bison. In illustrative embodiments, the one or more sources of protein can be powders and can include protein from casein or peas. In some embodiments, the pre-portioned amount of one or more sources of protein can be included in the first or second packet. In some embodiments, any of the packets or set of packets can be the first packet or first set of packets, any of the packets or set of packets can be the second packet or second set of packets, any of the packets or set of packets can be the third packet or third set of packets, and any of the packets or set of packets can be the fourth packet or fourth set of packets and do not indicate a specific order. For example, the first set of packets can include the carbohydrate packets and the second set of packets can include the spice-vegetable packets.

In some embodiments, one, some, or all of the packets can be prepared according to various standards. In some embodiments, one, some, or all of the packets can be sodium-free, salt-free, very low sodium, low sodium, reduced sodium, and/or less sodium. In some embodiments, one, some, or all of the packets do not include extra, additional, or supplemental sodium. In some embodiments, one, some, or all of the packets can include potassium chloride. In some embodiments, one, some, or all of the packets can be fat free, low fat, reduced fat, and/or less fat. In some embodiments, one, some, or all of the packets can have a low glycemic index. In some embodiments, one, some, or all the packets can have a medium glycemic index.

In some embodiments, one, some, or all of the packets do not include food coloring. In some embodiments, the one or more vegetables and/or the one or more sources of carbohydrates and/or the one or more spices and/or the one or more sources of protein have not been contacted with food coloring and/or the coloring has not been adjusted artificially. In some embodiments, one, some, or all of the packets do not include artificial preservatives. In some embodiments, the one or more vegetables and/or the one or more sources of carbohydrates and/or the one or more spices and/or the one or more sources of protein have not been contacted with artificial preservatives.

In some embodiments, the packets can be hermitically sealed. In some embodiments, the packets can be sealed under vacuum. In some embodiments, the packets can be sealed in a manner that can be opened by hand. In some embodiments, the packets can be made of plastic. In some embodiments, the packets can be sealed in reusable, re-sealable bags, for example using a plastic zipper. In some embodiments, the packets can be shelf-stable for at least 7, 14, 21, or 28 days or 1, 2, 3, 4, 5, 6, 7, 8, 9, 10, 11, 12, 15, 18, 21, 24, 30, 36, 42, 48, or 60 months at room temperature or about 25° C.

In some embodiments, the moisture content of the packets can be less than 1%, 2%, 3%, 4%, 5%, 10%, 15%, or 20%. In some embodiments, the one or more vegetables and/or the one or more sources of carbohydrates and/or the one or more spices and/or the one or more sources of protein can be air-dried and not subjected to a temperature below 0° C. In some embodiments, the one or more vegetables and/or the one or more sources of carbohydrates and/or the one or more spices and/or the one or more sources of protein can be exposed to temperatures of at least 1° C., 2° C., 3° C., 4° C., 5° C., 6° C., 7° C., 8° C., 9° C., 10° C., 15° C., 20° C., 25° C., 30° C., 32° C., 35° C., 40° C., 42° C., or 45° C. during air drying. In some embodiments, the one or more vegetables and/or the one or more sources of carbohydrates and/or the one or more spices and/or the one or more sources of protein can be exposed to temperatures between 1° C., 2° C., 3° C., 4° C., 5° C., 6° C., 7° C., 8° C., 9° C., 10° C., 15° C., 20° C., and 25° C. during air drying on the low end of the range and 5° C., 6° C., 7° C., 8° C., 9° C., 10° C., 15° C., 20° C., 25° C., 30° C., 35° C., 40° C., 42° C., and 45° C. during air drying on the high end of the range.

In some aspects, provided herein is a meal delivery service, wherein the meal delivery service delivers any of the enclosures or meal kits provided herein to a consumer. In some embodiments, the delivery service delivers the enclosure or meal kit to a person in need due to age, family demographics, geographic isolation, or health. The meal service can deliver the enclosure or meal kit to a homebound person due to health and/or age, to a person of age 55, 60, 65, and in illustrative embodiments, 70, 75, 80, 85, or in certain illustrative embodiments 90 years or older, to a person or family with a household income at or below a poverty level (for example as determined by the US government for the school system), or to a person who was released from a hospital or other medical facility within the last 1, 2, 3, 4, 5, 6, or 7 days, or to person at the time of release from a hospital or medical facility.

In some embodiments, the cost of each possible meal in a meal kit provided herein, or for a method provided by a method for preparing a food or an enclosure provided herein, to a person preparing the meal or to a service providing the meal kit to a person in need, is between $0.50 and $4 per meal, or between $0.90 and $2.00 per meal or between $0.90 and $1.50 per meal or between $0.90 and $1.10 per meal or about $1.00 per meal, using the cost of living in the U.S. in 2016. In some illustrative embodiments, the cost of goods per 200, 400, or 600 g serving of a meal kit provided herein is between 1/20 and ½ or between 1/10 and ¼ the hourly cost of a minimum hourly wage for the United States of America, or a state therein at the time the meal kit is prepared. In some illustrative embodiments, the cost to consumer per 200, 400, or 600 g serving of a meal kit provided herein is between 1/10 and ½ or between ⅕ and ¼ the hourly cost of a minimum hourly wage for the United States of America, or a state therein at the time the meal kit is prepared. Such meal kits can provide between 50 and 1000, 50 and 500, or 50 and 250 calories, and in some illustrative embodiments, between 50 and 200 or between 50 and 150 calories. In certain embodiments, the meal kit is delivered to, or meal is prepared by, a college student and/or a college dormitory or dormitory room.

It will be understood that references herein to a first, second, third, or fourth element such as a packet or set of packets are for convenience in drafting and do not indicate a specific order. A first set of packets, for example, can refer to any of the disclosed sets of packets set out in any aspect and/or embodiment. For example, a first set of packets in a method, enclosure, box, meal kit, or self-service machine herein can be a packet including a source of carbohydrates and a second set of packets can be a spice-vegetable packet.

The following non-limiting examples are provided purely by way of illustration of exemplary embodiments, and in no way limit the scope and spirit of the present disclosure. Furthermore, it is to be understood that any inventions disclosed or claimed herein encompass all variations, combinations, and permutations of any one or more features described herein. Any one or more features may be explicitly excluded from the claims even if the specific exclusion is not set forth explicitly herein. It should also be understood that disclosure of an element for use in a method is intended to be synonymous with (and provide support for) that method involving the use of that element, according either to the specific methods disclosed herein, or other methods known in the art unless one of ordinary skill in the art would understand otherwise. In addition, where the specification and/or claims disclose a method, any one or more of the elements disclosed herein may be used in the method, unless one of ordinary skill in the art would understand otherwise.

### EXAMPLES

### Example 1. Selection and Preparation of a Meal

This example demonstrates a senior citizen receiving a meal kit, selecting one packet of a mixture of spices and vegetable, selecting one packet of a source of carbohydrates, and preparing a meal using the packets. The example further demonstrates the senior citizen making a second meal with the remaining packets.

A senior citizen receives a meal kit with 8 total packets from a delivery service such as Meals on Wheels. The meal kit includes a first set of 4 packets with 1 packet each of a mixture of an Italian spice-blend, a Southwest spice blend, a Greek spice blend, or a Dutch Indies spice blend combined with air-dried carrots, onions, whole kernel sweet corn, celery, green beans, green and white leeks, green bell pepper, and red bell pepper. The meal kit also includes a second set of 4 packets with 2 packets of whole-wheat pearl couscous, 1 packet of quinoa, or 1 packet of basmati rice. The senior citizen selects the packet of Southwest spice blend with air-dried vegetables. Then, the senior citizen selects the whole-wheat pearl couscous packet. This brings a feeling of happiness to the senior citizen because she is reminded of a dish she used to prepare for her family when she was younger and able to cook meals from scratch using fresh ingredients. The senior citizen combines the contents of the packets in 1 cup of water in a microwave-safe bowl. Next, the senior citizen heats the mixture in a microwave for 2 minutes in a loosely covered container, according to the selected packets and instructions in the meal kit. After heating, the senior citizen allows the mixture to sit in the microwave for 10 minutes and then opens the lid. The senior citizen sees the cooked vegetables in the prepared meal resemble fresh samples of the same vegetables and eats the prepared meal.

One week later, the senior citizen selects, from the same meal kit, the packet of Greek spice blend with air-dried vegetables and the packet of quinoa. Then, the senior citizen combines the contents of the packets and 1 cup of water in a microwave-safe bowl and heats the mixture in the microwave for 2 minutes. After heating, the senior citizen allows the mixture to sit in the microwave for 15 minutes and then opens the lid. The senior citizen sees the cooked vegetables in the prepared meal resemble fresh samples of the same vegetables and eats the prepared meal. She gets a sense of satisfaction and pleasure that she was able to cook her own meal, and was able to select and make a different meal than she made previously with the meal kit. Furthermore, because the meal kits were low sodium and had a low glycemic index, she was able to make and eat two meals that are good for her health. In addition to enjoying the meal and gaining confidence from her ability to prepare the meal, she also learns that healthy foods can taste good and is learning how to eat and cook healthy.

While certain embodiments have been described in terms of the preferred embodiments, it is understood that variations and modifications will occur to those skilled in the art. Therefore, it is intended that the appended claims cover all such equivalent variations that come within the scope of the following claims.

What is claimed is:

1. A method for preparing a meal, comprising:
a) selecting, from a first set of packets, a spice-vegetable packet comprising a pre-portioned amount of one or more spices and a pre-portioned amount of one or more vegetables, wherein each packet of the first set of packets is a sealed packet comprising a different mixture of one or more spices and one or more vegetables, wherein the vegetables are whole vegetables or sliced vegetables having a volume of at least 1/20 the volume of the corresponding whole vegetable, and wherein the one or more vegetables have been air dried and/or have not been subjected to a temperature below 0° C.;
b) selecting, from a second set of sealed packets, a carbohydrate packet comprising a pre-portioned amount of one or more sources of carbohydrates wherein each packet of the second set of packets comprises a different source of carbohydrates;
c) combining the contents of the selected spice-vegetable packet and the contents of the selected carbohydrate packet into a volume of water to form a mixture; and
d) heating the mixture under conditions to cook the mixture for no more than 5 minutes in a microwave oven and allowing to sit in a closed container for no less than 5 minutes thereafter, thereby preparing the meal.

2. The method of claim 1, wherein the meal is prepared by combining no more than 2 total packets and wherein the first set of packets comprises at least 3 packets with different mixtures of one or more spices and one or more vegetables and the second set of packets comprises at least 3 packets with different sources of carbohydrates.

3. The method of claim 1, wherein after the heating, the one or more vegetables are identifiable visually.

4. The method of claim 1, wherein the one or more vegetables comprise green peppers, red peppers, green bell pepper, red bell pepper, yellow bell peppers, beans, green beans, bean sprouts, refried beans, onions, peas, water chestnuts, celery, carrots, corn, whole kernel sweet corn potatoes, green leeks, white leeks, kale, and/or tomatoes, and the one or more sources of carbohydrates comprise pasta, beans, rice, lentils, peas, and/or quinoa.

5. The method of claim 1, wherein the spice-vegetable packet further comprises a pre-portioned amount of one or more sources of protein.

6. The method of claim 1, wherein the packets are low sodium.

7. The method of claim 1, wherein the packets do not contain food coloring.

8. The method of claim 1, wherein the packets do not comprise artificial preservatives.

9. The method of claim 1, wherein the packets have a low glycemic index.

10. The method of claim 1, wherein the packets are shelf-stable for at least 6 months.

11. The method of claim 1, wherein the packets are low sodium, do not contain food coloring, do not comprise artificial preservatives, contain between 50 and 500 calories, have a low glycemic index, and are shelf-stable for at least 6 months.

12. The method of claim 1, wherein the selecting is performed using an online interactive system, an application on a cellular phone, or a vending machine.

13. The method of claim 1, wherein all the steps of the method are performed within a machine.

14. The method of claim 1, wherein the method is performed in a vehicle traveling in the atmosphere or in outer space.

15. The method of claim 1, wherein the packets are opened by unzipping a plastic zipper.

16. The method of claim 1, wherein the packets contain a moisture content of less than 10% water.

17. The method of claim 2, further comprising preparing a second meal, wherein the second meal is prepared by repeating steps a) to d) to select a different combination of the spice-vegetable packet and the carbohydrate packet.

18. A meal kit comprising an outer container and a plurality of packets located within the outer container, wherein the plurality of packets comprises:
a first set of packets, wherein each packet of the first set of packets is a sealed packet comprising a pre-portioned amount of a mixture of one or more spices and one or more vegetables, wherein the vegetables are whole vegetables or sliced vegetables having a volume at least 1/20 the volume of the corresponding whole vegetable, and wherein the one or more vegetables have been air dried and/or have not been subjected to a temperature below 0° C.; and
a second set of packets, wherein each packet of the second set of packets is a sealed packet comprising a pre-portioned amount of one or more sources of carbohydrates,
wherein the meal kit comprises at least total 6 total packets comprising the first set of packets and the second set of packets.

19. The meal kit of claim 18, wherein the first set of packets comprises at least 3 packets with different mixtures of one or more spices and one or more vegetables and the second set of packets comprises at least 3 packets with different sources of carbohydrates, and wherein the one or more vegetables are identifiable visually.

20. The meal kit of claim 19, wherein the packets are low sodium, do not contain food coloring, do not comprise artificial preservatives, have a low glycemic index, and are shelf-stable for at least 6 months.
